(19) United States
(12) Patent Application Publication
(10) Pub. No.: US 2006/0148421 A1
(43) Pub. Date: Jul. 6, 2006

(54) Method and apparatus for frequency adjustment

(75) Inventors: Patrick Huang, Taipei (TW); Wen-Chang Lee, Taipei (TW); Sen-You Liu, Taipei (TW)

Correspondence Address: REED SMITH LLP, Suite 1400, 3110 Fairview Park Drive, Falls Church, VA, 22042, US

(73) Assignee: Via technologies, Inc.

(21) Appl. No.: 11/027,984

(22) Filed: Jan. 4, 2005

(51) Int. Cl. H04B 1/40

(52) U.S. Cl. 455/76

(57) ABSTRACT

A method and an apparatus for shifting a resonance frequency in response to an operating frequency are provided. The present invention retrieves a control signal, from a frequency synthesizer, indicative of a difference between the operating frequency and a predetermined frequency, decodes the control signal to generate a tuning signal by looking up a mapping table, and tunes the resonance frequency in response to the tuning signal.

### FIELD OF INVENTION

The present invention relates to a method and an apparatus for dynamically shifting a resonance frequency in response to an operating frequency of electronic circuitry.

### BACKGROUND OF THE INVENTION

With rapid development of wireless communications in recent days, some systems for wireless communications operating at, for example, a GHz-level frequency are highly demanded. The designs of amplifiers particularly for such systems become a complex issue because the gains of the amplifiers are difficult to keep steady when the operating frequency of the systems shifts away from expectation values.

FIG. 1 shows an RF amplifier of the prior art. The RF amplifier includes a transistor M1 configured to amplify an input signal inputted from the node IN and to generate an amplified output signal outputted at the node OUT. Generally speaking, the operating frequency of a communication device is particularly aligned to the resonance frequency of the amplifier so as to obtain a maximum gain for amplification, and the resonance frequency is defined as the frequency value making the equivalent impedance maximum between the node OUT and ground. The curve 201 in FIG. 2 shows the change of the equivalent impedance over frequency. When the operating frequency matches the resonance frequency f1, the equivalent impedance also reaches its maximum Z1, and, therefore, the output signal is amplified with the maximum gain of the amplifier. If the operating frequency shifts from the resonance frequency f1 to, for example, a frequency f2, it is apparent that the equivalent impedance drops from Z1 to Z2. Because the curve 201 has a sharp peak, the decrement of equivalent impedance results in a huge gain loss and, hence, the communication device does not work in an optimal condition. The shift (from f1 to f2) of the operating frequency might take place when the operating frequency cannot be aligned perfectly as expected or simulated due to the deviation between the practical and theoretical characteristics of electronic elements. Unfortunately, the deviation happens frequently in a real world.

To solve this problem, the RF amplifier shown in FIG. 1 also includes an inductor L1, a capacitor C1 and a resistor R1. The three elements L1, C1, R1 are configured to reduce the frequency dependence of the equivalent impedance. While being arranged well, the three elements L1, C1, R1 will flat the curve 201. As FIG. 3 shows, the curve 301 represents the equivalent impedance after considering the effect of the elements L1, C1, R1. One can easily observe that the shift (from f1 to f2) of the operating frequency causes a slighter drop (from Z3 to Z4) of the equivalent impedance. Accordingly, the drawback of gain loss due to the shift of the operating frequency is partially reformed.

The gain loss problem is solved efficaciously by adding the elements L1, C1, R1, whereas another problem arises. That is, referring to FIG. 3, the peak of the curve 301 is much lower than the peak of the curve 201. The peak drop also results in huge gain loss even if the operating frequency stays at f1 as expected. Moreover, because the values of the elements L1, C1, R1 are fixed and cannot be adjusted in response to the change of operating frequency, the curve 301 is usually set flat enough to maintain a small drop of the equivalent impedance even under the situation of the operating frequency shifting from the resonance frequency significantly. To do so, the equivalent impedance would be suppressed so low that the gain for amplification is sacrificed. Therefore, an alternative solution to solve this problem is still required.

### SUMMARY OF THE INVENTION

The present invention provides a transceiver, an apparatus and a method which can dynamically shift a resonance frequency in response to an operating frequency without sacrificing gains.

The method for tuning or adjusting a resonance frequency in response to an operating frequency includes the steps of: (a) retrieving a control signal, from a frequency synthesizer, indicative of a difference between the operating frequency and a predetermined frequency; (b) decoding the control signal to generate a tuning signal by using a mapping table; and (c) tuning the resonance frequency in response to the tuning signal.

The step (c) may further include the steps of: (d) providing at least one inductor, at least one capacitor and a plurality of switches, wherein each switch is connected to one inductor or one capacitor; and (e) controlling each switch to change an impedance associated with the resonance frequency in response to the tuning signal.

The transceiver for transmitting an amplified signal includes a frequency synthesizer and an apparatus. The frequency synthesizer is configured to output a control signal indicative of the operating frequency of the transceiver. The apparatus includes an amplifier circuit and a tuner. The amplifier circuit, responsive to an input signal, is configured to generate the amplified signal. The tuner, responsive to the control signal, is configured to adjust the resonance frequency of the amplifier circuit by tuning the impedance of the amplifier circuit so that the resonance frequency can be shifted in response to the operating frequency.

The frequency synthesizer may include a digital frequency controller used to determine the operating frequency and to generate the control signal. The tuner may include a decoder, having a mapping table, to decode the control signal and to generate a tuning signal by looking up the mapping table. The amplifier circuit may include an amplifier and a tuning amplifier tank. The tuning amplifier tank includes at least one inductor, at least one capacitor and a plurality of switches. Each switch is connected to the amplifier as well as one inductor or one capacitor. The tuning amplifier tank, responsive to the tuning signal, controls each switch either on or off to change the impedance.

### BRIEF DESCRIPTION OF THE DRAWINGS

FIG. 1 illustrates an amplifier circuit of the prior art;

FIG. 2 illustrates the impedance of the amplifier circuit over frequency;

FIG. 3 illustrates the equivalent impedance of the amplifier circuit over frequency when some electronic elements are considered;

FIG. 4 illustrates an embodiment of the transceiver in accordance with the present invention;

FIG. 5 illustrates the block diagram of an exemplary frequency synthesizer;

FIG. 6 illustrates the block diagram of a decoder adapted for the embodiment;

FIG. 7 illustrates a mapping table adapted for the embodiment;

FIG. 8 illustrates an amplifier circuit adapted for the embodiment;

FIG. 9 illustrates a flow chart of the method in accordance with the present invention;

FIG. 10 illustrates further steps of tuning a resonance frequency in accordance with the present invention; and

FIG. 11 illustrates an exemplary amplifier circuit in accordance with the present invention.

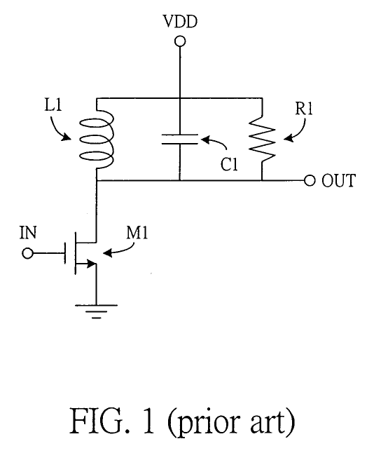

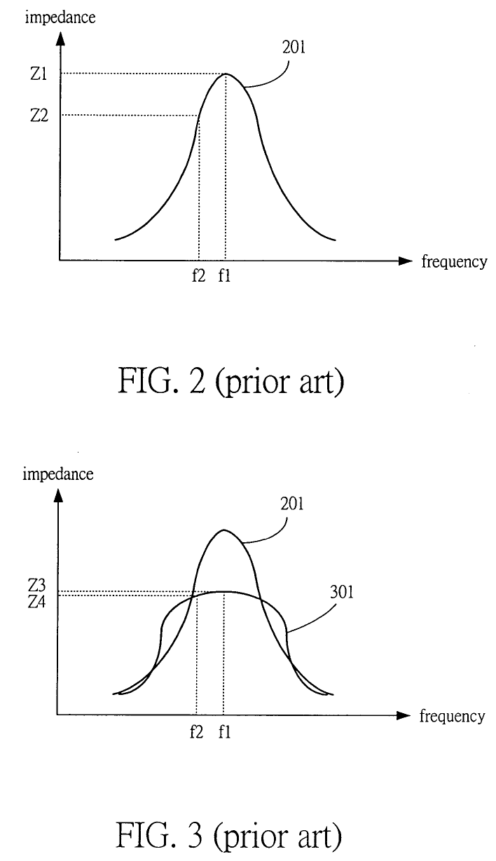

### DETAILED DESCRIPTION

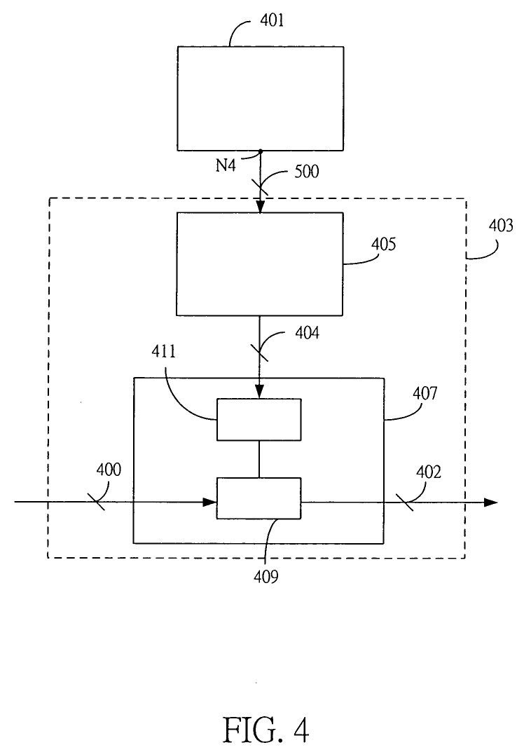

A transceiver in accordance with the present invention is capable of amplifying an input signal at its resonance frequency, which is adjusted dynamically in response to its operating frequency, to obtain a maximum gain. FIG. 4 shows the block diagram of an embodiment of the transceiver. The transceiver, adapted for mobile phones, includes a frequency synthesizer 401 and an apparatus 403. The frequency synthesizer 401 may be any kind of PLL frequency synthesizer in the prior art.

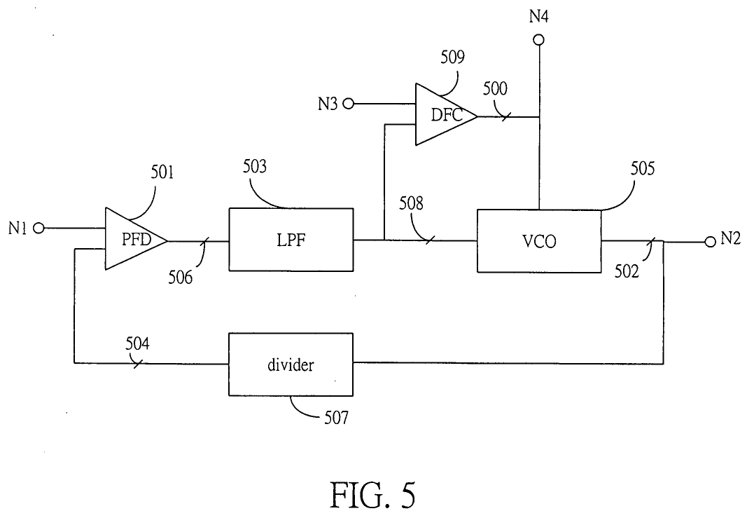

For example, as FIG. 5 shows, an implementation of the frequency synthesizer 401 may include a phase frequency detector 501, a low-pass filter 503, a voltage controlled oscillator 505, a divider 507 and a digital frequency controller 509. The frequency synthesizer 401 is to provide a reference frequency for the transceiver. The reference frequency is usually used as the operating frequency. Assuming a 1 GHz reference frequency 502 is required to be outputted at the node N2, the operation rationale is that: the divider 507 divides the reference frequency 502 by, for example, 1000 to generate a first signal 504 indicative of one-thousandth of the reference frequency 502; the phase frequency detector 501 compares the first signal 504 with a predetermined 1 MHz frequency inputted from the node N1 and generates a second signal 506 indicative of the difference between 1 MHz and one-thousandth of the reference frequency 502; the low-pass filter 503 filters the second signal 506 and generates a DC voltage 508 whose level represents the frequency difference between 1 GHz and the reference frequency 502; the digital frequency controller 509 compares the DC voltage 508 with a predetermined voltage, inputted from the node N3, to generate a 3-bit control signal 500 indicative of the frequency difference between 1 GHz and the reference frequency 502; and the voltage controlled oscillator 505 includes a tank capable of tuning the oscillation frequency of the voltage controlled oscillator 505 according to the control signal 500 so that the reference frequency 502, associated with the oscillation frequency, can be adjusted to be just 1 GHz.

For example, if the control signal 500 having a value of [100] represents the reference frequency 502 matches 1 GHz, then the control signal 500 having a value smaller than [100], i.e. [000], [001], [010] or [011], represents that the reference frequency 502 is smaller than 1 GHz, and the control signal 500 having a value larger than [100], i.e. [101], or [111], represents that the reference frequency 502 is larger than 1 GHz.

By retrieving the 3-bit control signal 500 from the node N4, the transceiver hence can obtain the information of the operating frequency, i.e. the reference frequency 502.

Referring back to FIG. 4, the apparatus 403 includes a tuner 405 and an amplifier circuit 407. The tuner 405 is configured to generate a tuning signal 404, in response to the control signal 500, to adjust the resonance frequency of the amplifier circuit 407 by tuning the impedance of the amplifier circuit 407. The amplifier circuit 407, receiving an input signal 400, is configured to amplify the input signal 400 and to output an amplified signal 402.

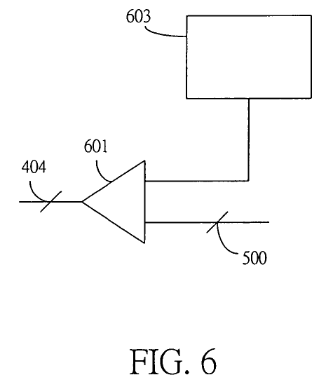

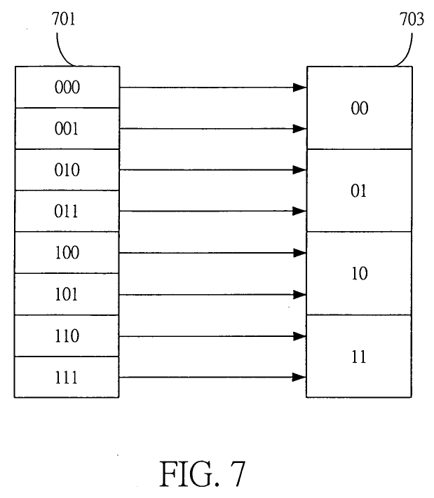

FIG. 6 shows an exemplary implementation of the tuner 405. The tuner 405 may include a decoder 601, having a mapping table 603, to decode the control signal 500 and to generate the tuning signal 404 by looking up the mapping table 603. FIG. 7 shows an exemplary implementation of the mapping table 603, wherein the table 701 represents the available 3-bit values of the control signal 500 and the table 703 represents the available 2-bit values of the tuning signal 404. When the control signal 500 is either [000] or [001], the decoder 601 determines the corresponding tuning signal 404 to be [00] by looking up the mapping table 603. Similarly, the control signal 500 having a value of [010] or [011] corresponds to the tuning signal 404 of the value [01]; the control signal 500 having a value of [100] or [101] corresponds to the tuning signal 404 of the value [10]; and the control signal 500 having a value of [110] or [111] corresponds to the tuning signal 404 of the value [11].

In the embodiment, the tuning signal 404 of the value [00] means the operating frequency is much smaller than the resonance frequency, the tuning signal 404 of the value [01] means the operating frequency is slightly smaller than the resonance frequency, the tuning signal 404 of the value [10] means the operating frequency is substantially equal to the resonance frequency, and the tuning signal 404 of the value [10] means the operating frequency is larger than the resonance frequency.

Although the control signal 500 is set to have a 3-bit value and the tuning signal 404 is set to have a 2-bit value, the present invention does not limit the number of bits of the control signal 500 and the tuning signal 404. In general, the control signal 500 is set to have an m-bit value and the tuning signal 404 is set to have an n-bit value, wherein m and n are integers and m>n.

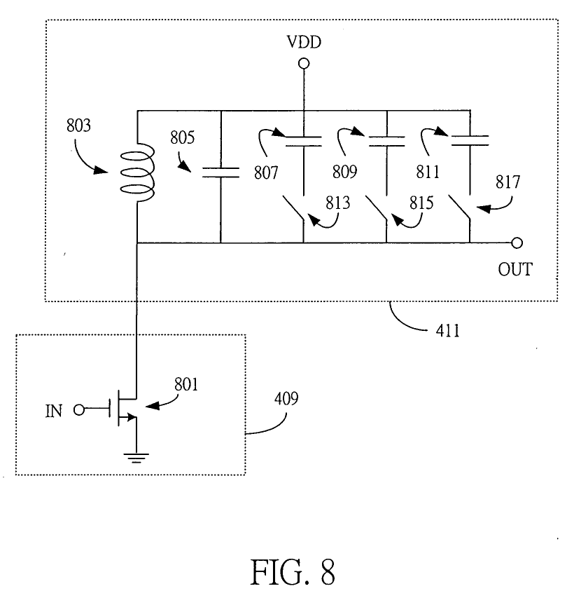

Referring back to FIG. 4, the amplifier circuit 407 includes an amplifier 409 and a tuning amplifier tank 411. FIG. 8 further shows the circuitry of the amplifier circuit 407.

The amplifier 409 includes a NMOS transistor 801 used for amplification. The tuning amplifier tank 411 includes an inductor 803, four capacitors 805, 807, 809, 811, and three switches 813, 815, 817. In response to the tuning signal 404, the tuning amplifier tank 411 controls the switches 813, 815, 817 either on or off to change the equivalent impedance of the amplifier circuit 407. If the tuning signal 404 is [10], the switches 813, 815 are on and the switch 817 is off. If the tuning signal 404 is [01], the switch 813 is on and the switches 815, 817 are off. If the tuning signal 404 is [00], all switches 813, 815, 817 are off. If the tuning signal 404 is [11], all switches 813, 815, 817 are on. The resonance frequency is thereby adjusted to follow the operating frequency.

The method of the present invention is capable of tuning or adjusting the resonance frequency of an amplifier in response to an operating frequency so that the gain of the amplifier can be maintained and the transceiver can work in an optimal condition.

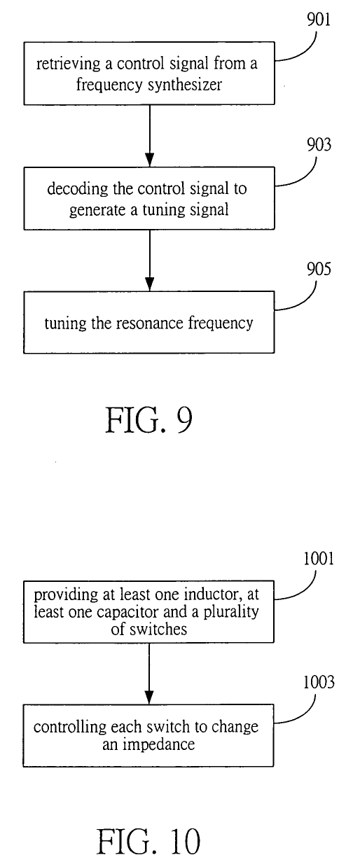

FIG. 9 shows the flow chart of the method in accordance with the present invention. In step 901, a control signal is retrieved from a frequency synthesizer. The frequency synthesizer herein may be any type of phase-locked loop (PLL) frequency synthesizer used in a modern RF transceiver. The control signal indicates a difference between a predetermined frequency and an operating frequency, wherein the predetermined frequency is a particularly designed frequency at which all circuits of the transceiver should operate and the operating frequency is the frequency at which all circuits of the transceiver practically operate. The operating frequency is supposed to match the predetermined frequency. The mismatch might occur if, for example, the deviation between the theoretical and practical characteristics of the circuits exists. In step 903, the control signal is decoded to generate a tuning signal by looking up a mapping table. In step 905, the resonance frequency is tuned in response to the tuning signal and, therefore, in response to the difference between the predetermined frequency and the operating frequency.

In general, the resonance frequency is adjusted to match the operating frequency so that the circuits are able to run at a consistent frequency. However, the present invention is also applicable if the resonance frequency is adapted for another stage of circuits which run at a frequency rather than but having a certain proportion to the operating frequency.

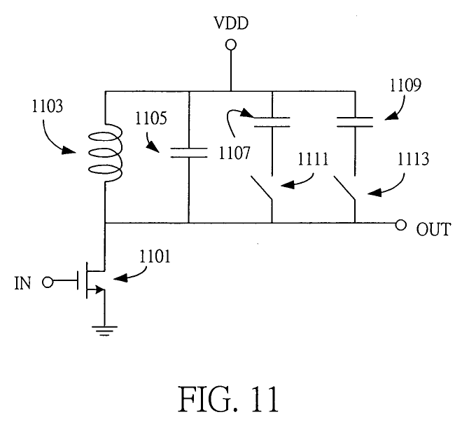

Step 905 may further include the steps shown in FIG. 10. In step 1001, at least one inductor, at least one capacitor and a plurality of switches are provided, wherein each switch is connected to one inductor or one capacitor. FIG. 11 shows an exemplary amplifier circuit for implementing step 1001. The amplifier circuit includes a transistor 1101, an inductor 1103, three capacitors 1105, 1107, 1109 and two switches 1111, 1113. The switch 1111 is connected to the capacitor 1107 and the transistor 1101. The switch 1113 is connected to the capacitor 1109 and the transistor 101. Although the switches 1111, 1113 are respectively connected to a capacitor, the present invention does not limit it. More specifically, the switches 1111, 1113, depending on practical needs, may be respectively connected to either an inductor or a capacitor. In step 1003, each switch, e.g. the switch 1111 or 1113, is controlled on/off according to the tuning signal to change an equivalent impedance between the node OUT and ground so that the resonance frequency is shifted thereby in response to the operating frequency.

The above description of the embodiment is expected to clearly expound that the present invention can dynamically shift the resonance frequency in response to the operating frequency without sacrificing gain. Those skilled in the art will readily observe that numerous modifications and alterations may be made while retaining the teaching of the invention. Accordingly, the above disclosure should be construed as limited only by the bounds of the claims.

1. A transceiver, responsive to an input signal, for transmitting an amplified signal, comprising:
a frequency synthesizer for outputting a control signal indicative of an operating frequency of the transceiver;
an amplifier circuit, having an impedance and a resonance frequency and responsive to the input signal, for generating the amplified signal; and
a tuner, in response to the control signal, for adjusting the resonance frequency by tuning the impedance.

2. The transceiver of claim 1, wherein the frequency synthesizer comprises a digital frequency controller for determining the operating frequency and generating the control signal.

3. The transceiver of claim 1, wherein the tuner comprises a decoder, having a mapping table, for decoding the control signal and generating a tuning signal based on the mapping table.

4. The transceiver of claim 3, wherein the control signal is an m-bit signal and the tuning signal is an n-bit signal, m and n are integers, and m>n.

5. The transceiver of claim 3, the amplifier circuit comprising an amplifier and a tuning amplifier tank, the tuning amplifier tank comprising at least one inductor, at least one capacitor and a plurality of switches, each of the switches being connected to the amplifier as well as one inductor or one capacitor, the tuning amplifier tank, in response to the tuning signal, controlling each of the switches to change the impedance.

6. An apparatus for generating an amplified signal by using a control signal generated by a frequency synthesizer, the control signal indicating an operating frequency of the apparatus, the apparatus comprising:
an amplifier circuit, having an impedance and a resonance frequency, for generating the amplified signal; and
a tuner, in response to the control signal, for adjusting the resonance frequency by tuning the impedance.

7. The apparatus of claim 6, wherein the tuner comprises a decoder, having a mapping table, for decoding the control signal and generating a tuning signal based on the mapping table.

8. The apparatus of claim 7, wherein the control signal is an m-bit signal and the tuning signal is an n-bit signal, m and n are integers, and m>n.

9. The apparatus of claim 6, the amplifier circuit comprising an amplifier and a tuning amplifier tank, the tuning amplifier tank comprising at least one inductor, at least one capacitor and a plurality of switches, each of the switches being connected to the amplifier as well as one inductor or one capacitor, the tuning amplifier tank, in response to the tuning signal, controlling each of the switches to change the impedance.

10. A method for tuning a resonance frequency according to an operating frequency, comprising the steps of:
retrieving a control signal, from a frequency synthesizer, indicative of a difference between the operating frequency and a predetermined frequency;
decoding the control signal to generate a tuning signal by using a mapping table; and
tuning the resonance frequency in response to the tuning signal.

11. The method of claim 10, wherein the tuning step further comprises the steps of:
providing at least one inductor, at least one capacitor and a plurality of switches, each of the switches being connected to one inductor or one capacitor; and
controlling each of the switches to change an impedance associated with the resonance frequency in response to the tuning signal.
